(19) United States
(12) Patent Application Publication
(10) Pub. No.: US 2009/0128504 A1
(43) Pub. Date: May 21, 2009

(54) Touch screen peripheral device

(76) Inventor: Garey Alexander Smith, Melbourne, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/985,785

(22) Filed: Nov. 16, 2007

(51) Int. Cl. G06F 3/041

(52) U.S. Cl. 345/173

(57) ABSTRACT

A touch screen peripheral device having a touch-responsive screen. The inventive device provides for both input to and output from an electronics system. A project/input designator display means provides at least one project/input designator on the touch-responsive screen, wherein the display properties of each project/input designator are customizable. A project retention means provides for the linking and saving of at least one specified resource that activates upon user selection of an associated project/input designator. The project retention means further provides for the linking of at least two specified resources with an associated project/input designator, wherein two or more specified resources are initiated by selection of a single project/input designator. Yet still, an offloading means may offload on-screen items from a main display screen to the touch-responsive screen either automatically or in response to user input, an event trigger, an application interaction or a state change.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention relates generally to the field of computer peripheral devices, and more particularly, but without limitation, is directed to a customizable touch screen peripheral device which greatly enhances both the display output and information input of at least one electronics system.

2. Background Art

A wide variety of input/output (I/O) devices are well known in the computer system arts. The vast majority of devices offer either input or output capabilities, but do not offer both functions concurrently. Prior art devices, such as remote controls having push buttons, include several setbacks and limitations including a lack of interactability and customization capability.

In most general purpose computer systems, commands and data are entered to the system from a typewriter-style keyboard and information from the system is displayed on a display screen or printed on a hard copy printing device. Where a display screen is used, the computer normally indicates the current entry position by displaying a distinctive marker called a cursor on the display screen. The cursor can take several forms but is usually a flashing underscore or rectangle or a graphical type pointer such as an arrow. The position of the cursor may be controlled in a number of ways. In some systems, a particular keystroke, or combination of keystrokes, is interpreted by the computer as a command to move the cursor to the right, left, up or down. Depending on the system and/or the particular software being used at a time, the cursor may be moved in increments of a single character position, an entire word, line, paragraph or pixel. In many systems, special keys are devoted to these functions and are usually located in a keypad separated from the typewriter keyboard.

Some systems also provide for a pointing device which can be used by the computer to control the location of the cursor on the display screen. Such devices include joysticks, paddles, light pens, touch panels, touch screens, and so-called “mice”. All of these devices enable an operator to “point” at a position on the display where the cursor is to be located.

Joysticks and conventional gaming controllers are perhaps the most widely known pointing devices due to their widespread use in video games. These devices are usually of the analog or fixed axis type having a plurality of button configurations. The simplest analog joysticks comprise a pair of potentiometers mechanically coupled to a movable handle at right angles to each other. The potentiometers form part of a voltage divider network and as the handle is moved, provide analog signals representing the X and Y coordinate position of the handle. The analog signals may then be converted to digital form for processing by a computer to locate the cursor. The cursor, or other point of interest, can therefore be positioned on the display screen by manipulating the handle. The fixed axis type of joystick is usually comprised of a handle mechanically coupled to a plurality of switches. Each switch represents an axis and direction of movement of the handle. In a 8-axis joystick, 4 switches are provided which indicate handle movement along a vertical, a horizontal and two-diagonal axes.

One example of a joystick known in the prior art is disclosed in U.S. Pat. No. 4,313,277 issued in the name of Eder. The Eder joystick provides a pair of 4 bit logic signals which represent the X and Y coordinate axis of the joystick handle. These signals are continuously scanned by an integral microcomputer along with the logic output signals from a small keyboard. The scanned signals are serially transmitted as a modulated infrared light signal to a receiver attached to a computer for demodulation and processing.

However, analog joysticks are difficult to control, have low resolution, are slow to move from one place to another, and their speed cannot be controlled. Such joysticks and controllers have very specific and thus limited uses which are primarily focused in gaming technology.

Mice represent another type of pointing device which has gained popularity with the proliferation of personal computers. Mice sit on a flat surface, such as a table top, and are moved about by hand. In some mouse systems, the movement of wheels or bearings within the mouse are coupled to switches to provide X and Y motion signals. In other systems, the movement of wheels is used to rotate an aperture which interrupts a beam of light to provide the X and Y coordinate signals. U.S. Pat. No. 4,369,439 issued to Broos, U.S. Pat. No. 3,541,541 to Engelbart and U.S. Pat. No. 3,541,521 to Koster disclose mice of the first category while U.S. Pat. No. 4,464,652 issued to Lapson discloses a mouse of the latter category.

Another type of mouse uses a glass grid. A light source inside the mouse is directed toward the grid to determine how many grid lines the mouse crosses as it is moved. This information is then provided to the host computer.

The user may customize the operations of a mouse and mouse pointer. Through a customization menu maintained by some conventional operating systems, the user may customize, for example, the assignment of a single click of a first mouse button to invoke a first function and the assignment of a single click over a second mouse button to invoke a second function. Further, the user may customize the appearance of the mouse pointer on the display screen. For example, one user may prefer a small arrow to be the mouse pointer, while another user may prefer a large blinking arrow. Similarly, some users may prefer a fast mouse pointer (i.e., small movements of the mouse's roller cause large movement of the mouse pointer), while other users may prefer a slower mouse pointer. This feature is referred to as the “sensitivity” of the mouse pointer.

These types of mouse and mouse pointer behaviors may be customized for each individual user. However, most operating systems provide customization for only one user on one system. Therefore, for a multi-user system, the user must re-customize the mouse from the prior setting. This typically involves the user editing a mouse settings file or local database that maps button behavior to one specific function. The prior art has not mapped button behavior to simultaneously execute more than one function. Additionally, mechanical mice require a large amount of table space to operate, are difficult to maintain in proper orientation, are limited in speed and also cannot be used to draw straight lines. Moreover, mice can readily fall off the operating surface and have a multitude of mechanical parts whose functionality can be affected by dust build-up. Optical mice share many of the same deficiencies as mechanical mice and also require a special operating surface.

The use of mice by way of its shape and method of use (e.g. continuous clicking motion of the primarily the index finger) has been known to attribute to carpel tunnel syndrome and thus its use, though effective, is not as ergonomic as other solutions, such as touch screen surfaces.

Light pens, touch screens and touch panels represent another significant class of pointing devices. Light pen and touch screens are used to detect a desired location on a display screen. Light pens usually have a switch in their side or tip which the user activates when the pen is positioned at the desired location on the display screen. The light pen then monitors when the pixel under the pen comes on. Based on a reference time signal, the location of the pixel on the display screen can then be determined. However, light pens require special display screens, are low in accuracy and are fragile in construction.

Touch screen technologies typically use some form of overlay on the display screen which, when touched, indicates to the host computer a corresponding location on the screen. Touch screens provide coordinate signals which represent a contact point on the screen. The coordinate signals are usually based on some form of grid scheme.

Conventional touch screens allow the user's finger or a pointing device to replace the conventional mouse and/or other possible input devices. Conventional touch screens utilize, for example, heat sensitive, sound sensitive, pressure sensitive, electromagnetic wave sensitive, or motion sensitive grids/detectors to detect a hand, finger, or object placed on the touch screen. However, conventional touch screens suffer certain limitations and disadvantages. Also, as a shortcoming of U.S. Pat. No. 5,808,605 to Shieh, the user cannot select a plurality of applications and/or customization features that evidence a substantial step forward from current customizations of conventional mice and mouse pointers. Conventional touch screens obstruct the current user's view, as well as the view of other possible multiple viewers depending on the method of use (e.g. TV viewing, interactive presentations, gaming, etc.). Conventional main display touch screens may block icons, applications, and other on-screen items disposed below the contact point on the touch-sensitive surface. Yet further, use of conventional touch screens requires significant arm motion, including raising and holding the arm in place, and a concomitant time delay. The use of conventional touch screens is very fatiguing and thus is not ergonomic, especially for continuous use.

Nevertheless, touch-sensitive computer input devices continue to offer the advantages of simplicity and reliability, as well as offering the ability to converge and/or combine multiple functionalities that were conventionally only available on independent peripheral devices. Furthermore, touch-sensitive computer input devices are not subject to size constraints imposed by mechanical considerations, an important factor in an era of increasing miniaturization. As an example, many customer oriented systems (e.g., ATM machines) and multi-user systems do not use mice. Rather, the trend for multi-user systems is to use touch screens.

Accordingly, there is a great need in the art for a touch screen peripheral device which overcomes the above described deficiencies in prior art peripheral devices while at the same time providing new I/O capabilities that enhance user functionality and experience and are also more effective, convenient, and easy to use. Moreover, different work and entertainment situations require the use of different applications and I/O configurations. Thus, there is also a need in the art for a universal or multimodal device to meet the needs and desires of various users and various computer programs. Accordingly, there would be great demand for a new I/O device that uses touch screen technology, but allows user customization of the peripheral device and its executable applications while at the same time physically divorcing the input touch screen from a possible main display screen of an electronics system so as to reduce main display screen clutter. In situations where it is advantageous to do so, the present invention reduces-obstructions due to user interactions that commonly occur on conventional devices where the touch input screen is also the main display screen.

### BRIEF SUMMARY OF THE INVENTION

The present invention provides for a peripheral device having a touch-responsive screen which greatly enhances both the input of information to and the output of information from at least one electronics system.

It is an aspect of the present invention to provide a peripheral I/O touch screen device having a touch-responsive screen that may be independent from a main display screen of at least one electronics system.

It is an aspect of the present invention to provide a freely customizable I/O device wherein users may configure the multimodal device to provide a plurality of useful operating functions.

It is an aspect of the present invention to provide for a project retention means to link and save at least two specified resources with at least one project/input designator.

It is an aspect of the present invention to provide for adaptive interaction between at least one electronics system and the present invention. Such adaptive interaction may occur at both a functional level as well as an aesthetic level (i.e. allowing for changes in color, texture, shape, shade, font, etc.).

It is an aspect of the present invention to provide a peripheral touch screen device which is easy to operate and interface with at least one electronics system, such as a host computer.

It is an aspect of the present invention to provide a peripheral touch screen device which is easy to operate and interfaces with at least two independent electronics systems.

It is yet still another aspect of the present invention to provide a peripheral touch screen device which is relatively small in physical size, convenient to operate, and may be fully portable. For example, a device of the present invention may range in size, but is not limited to such sizes, from that of a conventional keyboard to a convention PDA.

In accordance with one embodiment of the inventive disclosure, a portable touch screen peripheral device providing for communication and interaction with at least one electronics system, comprising a touch-responsive screen, the touch-responsive screen detecting contact from a user, wherein the touch-responsive screen is independent from the at least one electronics system, a project/input designator display means for displaying at least one project/input designator at specific coordinates on the touch-responsive screen, and a project retention means for linking and saving at least two specified resources that activate upon selection of a single project/input designator, wherein the communication between the portable touch screen peripheral device and the at least one electronics system is selected from the group consisting of a wired communication means and a wireless communication means.

### DETAILED DESCRIPTION OF THE INVENTION

Disclosed herein is an input/output (I/O) touch screen peripheral device that may be physically independent from at least one electronics system. One embodiment of such a device may include a touch-responsive screen that is divorced from a main display screen of the at least one electronics system. Such an embodiment may offload on-screen items from a main display screen (if present), especially on a cluttered display, to the touch-responsive screen either automatically when an application is loaded or upon an event trigger, such as a user input, an application event, or a state change. The embodiment may further comprise a project retention means that serves to link at least two specified resources to a single project/input designator for future launching of a workspace view. In a preferred embodiment, at least two specified resources are linked to a single project/input designator displayed on the touch-responsive screen, wherein selection of the one project/input designator simultaneously executes and/or launches the at least two specified resources to the main display screen and/or touch-responsive screen. Such use of at least one project/input designator provides for better organization, enhanced user productivity, greater interactivity, project or task suspension then resumption, and multitasking. A new project/input designator may further be created and saved via capturing the on-screen items that are currently active on the workspace. In this way an identical workspace may be recreated at a later time via user selection of the associated project/input designator.

These and other embodiments of the present invention may be realized in accordance with the following teachings and it should be evident that various modifications and changes may be made in the following teachings without departing from the broader spirit and scope of the invention. The specification is, accordingly, to be regarded in an illustrative rather than restrictive sense and the invention measured only in terms of the claims and their legal equivalents thereof.

For the purpose of the following discussion of embodiments of the present invention, illustrative terms are used. Definitions for certain such illustrative terms are as follows.

An “electronics system” may be understood to mean any one of a variety of devices for accessing data and/or communications. Examples of electronics systems include but are not limited to the following, and any combinations thereof: laptop computers, notebook computers; desktop computers, personal digital assistants, handheld computers, personal organizers; palmtop computers, pocket computers, cellular telephone/fax devices, gaming consoles, digitizing tablet devices, electronic books, digital audio recorder/players, televisions, stereo systems, home theater systems, cable/satellite television boxes, digital video recorders (DVR), digital program guide boxes, internet video and/or music devices, electronic home appliances, home environmental controls, and the like.

A “display” may be understood to mean any one of a variety of devices for displaying data, text, video, images, icons, and the like. It may comprise a continuous or discontinuous, flat, curved or flexible display surface including but not limited to a combination of one or more of the following technologies: liquid crystal with amorphous silicon thin-film transistor, metal-insulator-metal, or polysilicon thin-film transistor active matrix displays or liquid crystal with color super-twist nematic, double-layer supertwist nematic, high performance addressing, or dual scan passive matrix displays; back lit displays; electroluminescent displays; gas plasma displays; plasma addressed liquid crystal displays; digital visual interface displays; field emission displays; cathode ray tube displays; thin cold cathode displays; organic light-emitting diode displays; light-emitting polymer displays; touch screen displays using multi-wire resistive, surface wave, touch-on-tube, or infrared touch sensing; interlaced or progressive scanned displays; heads-up displays; back-projecting displays; reflective displays; projector displays (e.g. digital light processors (DLP); holographic autostereoscopic displays, and the like.

“On-screen items” may be understood to comprise a wide variety of items including but not limited to icons, toolbars, popup applications, input applications, entertainment controls, display options, program guides, program information, menu options, application controls, buttons, message boxes, thumbnails, files, graphical components of images or videos, zooming components, alerts or warnings, selection lists or menu lists, collapsed or minimized resources, clipboard items, active or open application windows, shortcuts and links, databases, database entries, search results, components or sub-components of other applications, input applications with feedback, and the like.

A “specified resource” may be understood to comprise a web page, an executable command or program, a keystroke combination, a file, one or more icons or links, a menu, a menu option, a list selection, an input search box, a database, a database entry, a folder, and any other software or operating system resource known within the art.

A “project/input designator” may be understood to comprise an icon, a control button, a selection list entry or menu option in the form of a thumbnail, an image, text, a symbol, a graphics interchange format (GIF), a virtual button, shortcuts, a video clip, an offloaded screen item, and the like. Additionally, a project/input designator may comprise a form input such as a radio button, text box, search box, file upload field, checkbox, text area, a submit button, a control button, and the like. Such a project/input designator may be linked to a saved workspace layout defined by a plurality of specified resources associated thereto.

The “properties” of the at least one project/input designator may be understood to comprise the size, shape, location, image content, video content, subject content, date content, user content, keyword content, description content, symbol content, text content, and the like.

A “project retention means” may be understood to comprise a means of allowing a user to more easily multitask by selecting a project/input designator that launches a saved or predetermined workspace that incorporates all of the user desired resources. The project retention means may both link and save a plurality of specified resources that are activated upon selection of a single project/input designator.

An “offloading means” may be understood to comprise a means for offloading, duplicating or re-expressing on-screen items or system controls from the main display screen to the touch-responsive screen of the touch screen peripheral device. If the at least one electronics system does not contain a main display screen, system controls may be offloaded or re-expressed by displaying such system controls on the touch-responsive screen of the present invention. “Re-expression” may provide the same general information, look or feel as found in the primary source, but in a different form, style or format.

A “device constituent” may be understood to comprise at least one project/input designator, on-screen items, an application-based control, another input interaction, another output interaction, and the like.

An “occurrence” may be understood to comprise an application-based automatic offload, an event trigger, a state change, user input, and the like

Now turning to the present invention, a touch screen peripheral device will be disclosed for facilitating user interaction with one or more electronics system. While the present invention may be used to communicate and interact with a single electronics system, the invention, preferably, serves to centralize user interaction with at least two or more electronics systems. The present invention, with its virtual or emulated buttons, may serve to replace or complement mechanical push-buttons of electronics systems, wherein such buttons may be located on system remote controls or disposed directly on electronics system components. Conventional electronics systems, such as computers, stereos, and cable boxes, typically incorporate a wide variety of on-screen items onto a main display screen of the specific system. For example, a computer may display pictures, video, active windows, icons, toolbars, popup applications, input applications, other menu options, and the like. A stereo may selectively display volume range, track selection, play time, and equalizer information. While a cable box may display volume range, channel selection, program guides, program information, and other menu options. All such on-screen items detrimentally cover and clutter the main display screen of each respective system. The peripheral touch screen device of the present invention may function to either automatically offload such on-screen items from the main display screen to the independent touch-responsive screen or offload such on-screen items at the occurrence of an event trigger. In this manner, the main display screen is relieved of clutter and such on-screen items remain available and fully functional on the touch screen peripheral device of the present invention.

On-screen items may comprise a wide variety of items including but not limited to icons, toolbars, popup applications, input applications, entertainment controls, display options, program guides program information, menu options, application controls, buttons, message boxes, thumbnails, files, graphical components of image or video, zooming components, alerts or warnings, selection lists or menu lists, collapsed or minimized resources, clipboard items, active or open application windows, shortcuts and links, databases, database entries, search results, components or sub-components of other applications, input applications with feedback, and the like.

Touch-responsive screens are well known within the art and are becoming more commonly utilized within electronics systems, such as computer systems. A conventional computer system as well as a touch screen peripheral device in accordance with one embodiment of the present invention may each include a central processing unit (CPU), read only memory (ROM), random access memory (RAM), input/output (I/O) circuitry, and a main display screen. The computing system may further include a touch screen display adapter for connecting the system bus to an I/O touch screen display device. The computer system may also be “pen-capable,” meaning that a stylus or pen may be used for inputting information either into the device of the present invention or into another component of the computer system if desired, but that other means of input are also anticipated. Such a computer system may also optionally include a mass storage unit such as a disk drive unit or nonvolatile memory such as flash memory, a keypad, and a clock.

The CPU is preferably a commercially available, single chip microprocessor. The CPU may be coupled to the ROM by a unidirectional data bus. The CPU may be connected to the RAM by a bi-directional data bus to permit the use of the RAM as scratch pad memory. The ROM and RAM are also coupled to the CPU by appropriate control and address busses, as is well known to those skilled in the art. The CPU may also be coupled to the I/O circuitry by bi-directional data bus to permit data transfers with external devices.

I/O circuitry typically includes a number of latches, registers and direct memory access (DMA) controllers. The purpose of I/O circuitry is to provide an interface between the CPU and external devices, such as that found between a conventional computer system and the touch screen peripheral device of the present invention. This includes wireless interface technologies that use electromagnetic waves, infrasound, or ultrasound to transmit information (e.g. 802.11g).

A touch-responsive screen of the present invention may act as both an input and an output device. Accordingly, such touch-responsive screens may be coupled to I/O circuitry by a bi-directional data bus. When operating as an output device, the touch screen peripheral device receives data from I/O circuitry via bus and displays that data on its touch-responsive screen. A preferred embodiment of the touch-responsive screen of the present invention is a liquid crystal display (LCD) of the type commercially available from a wide variety of manufacturers.

One skilled in the art readily recognizes how conventional touch screens operate, how conventional touch screen device drivers communicate with an operating system, and how a user utilizes a touch screen to initiate the manipulation of objects in a graphical user interface (GUI). For example, touch screen technology includes electronic sensors positioned inside a flexible membrane covering a computer screen, a grid of infrared signals, or a method of detecting a touch by sensing a change in heat, pressure, motion, electromagnetic wave reflection, or sound wave reflection. Using current touch screen technology, a user may initiate the display of a pull down menu by touching the touch screen, and then selecting an object within that menu by dragging a finger down the pull down menu, in addition, selecting project/input designators that interact with applications may affect the main display screen of at least one electronics system and/or the touch-responsive screen of the present inventive device. In such a manner, two-way display and input interactions are possible between the main display screen and the peripheral device of the present invention by way of the active application.

An embodiment of the present invention may incorporate a GUI and an operating system (OS) which may reside within a computer-readable media and contain a touch screen device driver that allows one or more users to initiate the manipulation of displayed project/input designators and text on the touch-responsive screen of the present invention. Any suitable computer-readable media may retain the GUI and operating system, such as ROM, RAM, disk and/or tape drive (e.g., magnetic diskette, magnetic tape, CD-ROM, optical disk, or other suitable storage media).

A touch-responsive screen of a device of the present invention may include any conventional, suitable touch screen that is sensitive to any physical interactions known within the art, including but not limited to, heat, pressure, motion, electromagnetic wave reflection, or the sound of fingertips and/or other known objects. Any suitable touch screen technology may be used in a device of the present invention. Moreover, more than one finger or object may be detected at a time on the touch-responsive screen.

In one example, the touch-responsive screen may be a thin, clear membrane which covers an LCD display and which is sensitive to the position of a stylus or fingertip on its surface. With such a structure, the touch-responsive screen may serve as an input “tablet.” Such position sensitive membranes are readily available on the commercial market. Combination touch-responsive screens such as the touch screens which include both the LCD and the input membrane are commercially available from vendors such as Scriptel Corporation of Columbus, Ohio.

Some type of mass storage is generally considered desirable on a device of the present invention. Mass storage may be coupled to I/O circuitry by a bi-directional data bus. However, the mass storage can be eliminated by providing a sufficient amount of RAM to store user application programs and data. In that case, the RAM could be provided with a backup battery to prevent the loss of data when the device of the present invention is turned off. However, it is generally desirable to have some type of long term storage such as a commercially available miniature hard disk drive, non-volatile memory such as flash memory, battery backed RAM, PC-data cards, or the like.

Many consumers commonly experience touch screen technology in use at public kiosk terminals, such as those found at grocery stores and airport check-in locations. The touch-responsive screen may include a plurality of programmable display regions configured to recognize input from a user interacting with the display screen. The touch-responsive screen may be configured to receive input through manual contact, through electronic contact with a specially configured stylus that transmits a signal to the display, or any other means known within the art. Each of these kinds of displays and stylus is well known in the art. One example of a touch sensitive display screen is the Stylistic 3500 Tablet computer made by Fujitsu Computer Systems Corporation having a base for United States business in Sunnyvale, Calif.

Distinct from tablet computers known within the art, embodiments of the present invention may be useful as stand alone tablet computers or as touch screen peripheral devices for pre-existing electronics systems. To date, writing tablet computers have found only limited usability in particular limited fields, such as the medical field, where relatively little input is required. It is believed that due to the perceived limited functionality of writing tablets, the use of writing tablets in the business industry has failed. Similarly, the use of primary and secondary display screens, particularly touch-responsive secondary displays, with conventional computer systems has not been very successful. Through this unique combination of a touch screen peripheral device and one or more pre-existing electronics systems, it is believed that many areas within the electronics industry will now be able to find marketing success and greater end consumer usefulness.

The touch screen peripheral device, apart from being incorporated with a computer system, may also be packaged as a separate I/O device, to be coupled to at least one electronics system thereafter via a wired or wireless communication means. As an input device, the present invention may function as a pointing device with multiple programmable “buttons,” as a keying device, or as a combination of both as previously described.

The layout of the touch screen peripheral device, because it is unlike existing I/O devices, may be initially unfamiliar to users. This unfamiliarity may result in some reluctance on the part of new users to adopt such a novel and unique I/O device. This unfamiliarity may be overcome at least in part by a user's ability to fully customize and configure the layout displayed on the touch-responsive screen of the present inventive device.

The present invention may further incorporate a project/input designator display means capable of generating at least one project/input designator on the touch responsive-screen. A project/input designator may include an icon, a control button, a selection list entry, or menu option in the form of a thumbnail, an image, text, a symbol, a graphics interchange format (GIF), a virtual button, shortcuts, a video clip, an offloaded screen item, and the like. Additionally, a project/input designator may comprise a form input such as a radio button, text box, search box, file upload field, checkbox, text area, a submit button, a control button, and the like. The project/input designator display means allows a user to fully customize and configure the properties of the at least one project/input designator. Such properties may include but are not limited to size, shape, location, image content, video content, subject content, date content, user content, keyword content, description content, symbol content, text content, and other such properties known within the art. In this manner, a user may uniquely configure and adapt the format of the project/input designator display on the touch-responsive screen of the device of the present invention. Further, any newly developed project/input designators may thereafter be loaded onto the present inventive peripheral device. Additionally, project/input designators may be searchable items to facilitate user selection of the desired project. Users may have the ability to add and/or modify searchable fields to each project/input designator, such fields may include but are not limited to subject content, date content, user content, keyword content, description content, symbol content, text content, and the like.

The present invention further provides for a GUI to assist a user in their use of the touch screen device and the icons displayed thereon. Initially, the touch-responsive screen displays various GUI features. A user may touch the touch-responsive screen to provide user input, for example, to navigate around a document or invoke a desired function. The touch-responsive screen may function in a variety of methods, as are well known within the art. For example, an analog controller may scan the touch screen and read the corresponding analog voltage of the touch screen. The analog controller may then convert the analog values into corresponding digital values representing the Cartesian coordinates, which are transmitted to the CPU for processing. The resolution of the touch input may depend on the ability of the analog controller to discern among multiple levels of analog values, generally defined in bits.

In addition to general cursor positioning determinations on the touch-responsive screen, the device of the present invention may also incorporate other characteristics of a user's touch, e.g., gestures or movements, to simplify GUI and maximize screen real estate. A gesture recognizing interface extends the ability of the present invention to distinguish between cursor coordinate location and tracking gestures and movements of user input based on vector direction and magnitude, all in the context of an active user application. This type of contextual gesture interface can infer by context, the gesture chosen by the user and what function or functions the user wishes to invoke. Accordingly, all these functions are available without menus or scroll bars and do not require additional screen areas to display the functions. Such multi-touch pattern recognition may allow for a user to save and link any input shape to a desired action or function. Input shapes may be created in a variety of means, including but not limited to, a user holding down their finger on the touch-responsive screen, creating a pattern with their finger, and then removing their finger from the screen at the end of the pattern. Such a movement may be recognizable by various software programs, and such pattern, for example, may function to provide combination moves when used in the gaming arts.

The device of the present invention may recognize other characteristics of the touch input including the context of the input, namely the task or sub-task applications running when the GUI is invoked. If a user is in a document navigation application, for example, the device may interpret a quick drag to the right as a next page function. If the underlying task is an editing application, the device may interpret the same gesture as a highlight function and highlight a portion of the document touched by the user. Similarly, in a graphics application, a quick drag to the right may invoke a drawing tool to draw from the starting point to the ending point of the touch points. In a document viewing application, the same touch may invoke a navigation tool to move the view of the document in the direction of the finger drag. The above examples are illustrative only and should not be interpreted as limiting nature.

Similarly, the device of the present invention may store pre-set display properties, set by either the user or the application developer, for the touch-responsive screen depending on the task or sub-task application(s) currently running on the device. In this way, a new interactive display may be shown on the touch-responsive screen when certain applications are running and other project/input designators may be loaded onto the device after the fact. As described, users may freely customize, configure, and save such display properties and link them to desired application(s). In this manner, a user's optimal display configuration may be automatically depicted on the touch-responsive screen, depending on the application(s) currently running and/or state changes within such applications. For example in the gaming arts, a change in a game character's environment or location within a game may function as a state change prompting a change in the display configuration on the touch-responsive screen of the present invention.

The present inventions further provides for a project retention means that links and saves at least two specified resources that are activated upon selection of a single project/input designator. Such customization capabilities are beyond the customization capabilities of a conventional mouse. Such a project retention capability allows a user to more easily multitask by selecting a project/input designator that launches a saved or predetermined workspace that incorporates all the user's desired resources. In this manner, a user may save multiple applications or resources that are frequently utilized together, such as for either business or personal use. Such specified resources may include but are not limited to a software application, a web page, an executable command or program, a keystroke combination, a file, one or more icons or links, a menu, a menu option, a list selection, an input search box, a database, a database entry, a folder, and any other software or operating system resource known within the art. For example, if a common project or task requires concurrent use or reference to a specific web page, word processor, and another application, the project retention means of the present invention may link and save each specified resource under a single project/input designator. The device of the present invention may further provide a means to store the present display state of the touch-responsive screen, or workspace, as a saved project that may be reloaded at a later time. Thus, when customized by the user, activation of the single project/input designator may cause the execution of at least two or more specified resources. In more specific terms, a project/input designator may execute one or more programs, launch one or more applications, or any combination thereof. As in the example, selection of the single shared project/input designator may cause execution of three specified resources, such as a specific web page, a word processor, and another application, which were all pre-selected by the user or application developer.

All of the functions and features described above focus on providing intuitive GUIs and minimize the need for users to memorize complicated, hierarchical menus or procedures. Additionally, the present invention maximizes available screen real estate while providing a wide array of GUI and tools.

Yet further, the present inventive device may incorporate an offloading means for offloading on-screen items from the main display screen of an electronics system to the touch-responsive screen of the touch screen peripheral device. The scope of offloading on-screen items further comprises duplicating or re-expressing on-screen items, or what would otherwise be on-screen items (if electronics system lacks a main display screen), from a main display screen to the touch-responsive screen of the present invention. Such re-expression may comprise the transfer of the same general information, look, or feel but in a different form, style or format. Offloading may occur automatically via preset criteria or upon a user interaction, application interaction, state change, or event trigger, such as user selection of a specified button, key or icon. A program or function of an electronics system may interact with the peripheral device of the present invention. Such interaction may react to the current state of the electronics system and the active display or active project on the peripheral device of the present invention and may automatically change depending on the active process, program or application on the electronics system. These automatic application-based display state changes may be customized and saved by a user or pre-set by third party application developers.

Such interactions may comprise input interactions, output interactions, or both, which may change or affect a device constituent. A device constituent may include but is not limited to at least one project/input designator, on-screen items, an application-based control, another input interaction, another output interaction, and the like. Such interactions may be initiated by an occurrence. An occurrence may include but is not limited to an application-based automatic offload, an event trigger, a state change, user input, and the like.

To facilitate the offloading process, a software development means allowing for independent software development, such as a software development kit (SDK) and/or customized Operating System (OS) platform may be provided. Such a software platform for independent application development may provide for input interactions and output interactions between the touch screen peripheral device and at least one electronics system. An SDK may provide a programming package that enables a programmer to develop applications for a specific platform. An SDK may allow for the development of Original Equipment Manufacturer (OEM) software applications to provide for touch screen interactions with home and office electronics systems in a manner consistent with the offloading and project/workspace saving capabilities of the present invention. The SDK may also provide an OEM development platform to develop virtual or emulated buttons or controls that could either replace or complement mechanical push buttons on remote controls or on other electronic devices.

Typically an SDK may include one or more application program interfaces (API), programming tools, and pertinent documentation. It is a relatively easy matter to provide software programming to permit the user to exclude certain non-essential on-screen items on the main display screen of at least one electronics system while offloading those display matters to the touch-responsive screen of the present invention. For example, when describing a document that is being displayed on the main display screen, the operator may want to offload such non-essential on-screen items as toolbars, display options, or program information to the touch-responsive screen so as not to clutter the main display screen of the electronics system. Conventional multi-display systems are limited in that they only allow for manual repetitive drag-and-drop movement of specific on-screen items between a primary display source and a secondary display source.

An SDK or customized OS may provide functionality in addition to an offloading means and/or project retention means. Such additional functionality may also allow OEM applications to be designed or adapted to control at least one electronics system, with or without a main display screen. Further functionality may allow OEM applications to interact between the present inventive device and at least one electronics system, as to the offloading means occurring either automatically or upon user input, an application action, a state change, or event trigger.

The present invention further comprises a means of communication between the touch screen peripheral device and one or more independent electronics systems. Such communication may generally occur via a wired communication means or a wireless communication means with the one or more electronics systems. Known wireless communication means include, but are not limited to, radio communications such as that defined in Institute of Electrical and Electronic Engineers (IEEE) specification 802.11 commonly known as WiFi, a Wide Area Network (WAN), a Local Area Network (LAN), Bluetooth, cellular/mobile communications, electromagnetic waves such as radio frequency (RF), infrared (IR), and microwaves, sound waves such as infrasound and ultrasound, and the like. Known wired communication means include, but are not limited to, any serial, parallel, synchronous, asynchronous, Peripheral Component Interconnect (PCI), Personal Computer Memory Card International Association (PCMCIA), Industry Standard Architecture (ISA), Small Computer Systems Interface (SCSI), Integrated Drive Electronics (IDE), Ethernet, Universal Serial Bus (USB), fiber optic, Firewire, bus interface, High-Definition Multimedia Interface (HDMI), composite video, RCA, and the like. Such wired, wireless, or any combination of such communication means between the disclosed inventive device and the at least one electronics system, or between any other elements of the system, are contemplated within the scope of the present invention. As an example, RF transmissions between the inventive device and a conventional laptop or desktop computer system are one possible embodiment within the scope of the present invention. Such wireless communication embodiments may be especially useful with peripheral touch screen devices of the present invention as has been found with other small, readily portable I/O devices.

In use, touch screen peripheral devices of the present invention may be used as stand-alone devices with functionality similar in nature to a laptop computer or the devices may be seamlessly integrated with a multitude of independent electronics systems. To maintain such versatility, the user saved memory of project configurations, display properties, and the like may be stored externally on each respective electronics systems or internally on the device of the present invention to maintain complete portability.

Using a touch screen peripheral device of the present invention, the user is provided with a substantial increase in the overall display area as compared to only a main display screen of most conventional electronics systems. The touch-responsive screen may be programmed to display the same information as is displayed on the main display screen, may be programmed to operate as an entirely separate display with its own information to display, and may be programmed, along with the first display screen, to display half of the information on the main display screen and the second half of the information on the touch-responsive screen (e.g. split screen views for gaming or PIP).

A plurality of fields of use exists for a touch screen peripheral device of the present invention which may separate the input versatility from the main display screen of an electronics system. Examples include but are not limited to: searching for and offloading program guides and program information from cable and satellite television services; offloading home management menus and functions with such modern homes becoming processor-centralized; offloading video game console input commands whereas simple or complex input patterns and/or combinations may be stored as touch screen project/input designators; offloading picture and video thumbnails; previewing offloaded video clips or movies before viewing on a main display screen; offloading video streams and stored videos including both full length videos and video clips, such as one or more Picture-In-Picture (PIP) display windows; offloading color input palettes as is used with digital painting applications; offloading multimedia buttons for both sound and video input, output, and editing; offloading internet video and music controls; offloading DVD and DVR control and menu options; offloading conventional mouse input functionality; offloading conventional keyboard and number pad functionality; offloading internet-based context-aware content such as popups, web listings, and websites; offloading application message boxes and user interactive response buttons, options, text inputs, and/or selections (e.g. for questions, surveys, etc.); and the like.

Devices of the present invention may be configured to function in only one method of use, or the devices may be fully compatible with all available uses wherein the electronics system to be controlled may be selected from an available listing of two or more electronics systems. Such a listing may be generated by location awareness where each electronics system advertises, preferably wirelessly, their presence, use, and/or capabilities to the touch screen peripheral device of the present invention.

A wide variety of convenient functionality may further be included in a device of the present invention. Examples may include but are not limited to text-based content search capability, panning and/or zooming capability for objects displayed on the touch-responsive screen, video and/or voice input, power saving functions such as automated power on/power off and a screen saver, return to main menu function, forward and backward functions, return to active viewing screen function, speech recognition capability, and the like.

Given the preferred portability of the peripheral device of the present invention, the power supply means may include but is not limited to a wired AC/DC wall unit, replaceable batteries, rechargeable batteries, any combination thereof, and the like. Additionally, the present inventive device or the touch-responsive screen of the present inventive device may be set to hibernate after a definite period of user inactivity to further conserve power.

It will be apparent to those skilled in the art that various modifications and variations can be made in the device of the present invention and in construction of this device without departing from the scope or spirit of the invention. Other embodiments of the invention will be apparent to those skilled in the art from consideration of the specification and practice of the invention disclosed herein. The specification and examples should be considered as exemplary only, with the true scope and spirit of the invention indicated by the appended claims and their legal equivalents.

What is claimed is:

1. A portable touch screen peripheral device providing for communication and interaction with at least one electronics system, comprising:
a touch-responsive screen, said touch-responsive screen detecting contact from a user, wherein said touch-responsive screen is independent from said at least one electronics system;
a project/input designator display means for displaying at least one project/input designator at specific coordinates on said touch-responsive screen; and
a project retention means for linking and saving at least two specified resources that activate upon selection of a single project/input designator;
wherein said communication between said portable touch screen peripheral device and said at least one electronics system is selected from the group consisting of a wired communication means and a wireless communication means.

2. The portable touch screen peripheral device of claim 1, wherein properties of said at least one project/input designator are customizable by said user, said properties are selected from the group consisting of size, shape, location, image content, video content, subject content, date content, user content, keyword content, description content, symbol content, and text content.

3. The portable touch screen peripheral device of claim 1, wherein said portable touch screen peripheral device communicates with at least two independent electronics systems.

4. The portable touch screen peripheral device of claim 1, further comprising:
an offloading means for offloading on-screen items from a main display screen of said at least one electronics system to said touch-responsive screen, wherein said portable touch screen peripheral device is independent from said main display screen of said at least one electronics system.

5. The portable touch screen peripheral device of claim 1, further comprising:
a software platform for independent application development that provides for input interactions and output interactions between said portable touch screen peripheral device and said at least one electronics system.

6. The portable touch screen peripheral device of claim 1, wherein said interactions comprise input interactions and output interactions capable of affecting a device constituent, said device constituent is selected from the group consisting of said at least one project/input designator, on-screen items, an application-based control, another said input interaction, and another said output interaction.

7. The portable touch screen peripheral device of claim 1, wherein said interactions are initiated by an occurrence, said occurrence is selected from the group consisting of an application-based automatic offload, an event trigger, a state change, and user input.

8. A portable touch screen peripheral device providing for communication and interaction with at least one electronics systems, comprising:
a touch-responsive screen, said touch-responsive screen detecting contact from a user, wherein said touch-responsive screen is independent from said at least one electronics system;
a project/input designator display means for displaying at least one project/input designator at specific coordinates on said touch-responsive screen; and
an offloading means for offloading on-screen items from a main display screen of said at least one electronics system to said touch-responsive screen, wherein said portable touch screen peripheral device is independent from said main display screen of said at least one electronics system;
wherein said communication between said portable touch screen peripheral device and said at least one electronics system is selected from the group consisting of a wired communication means and a wireless communication means.

9. The portable touch screen peripheral device of claim 8, wherein said portable touch screen peripheral device communicates with at least two independent electronics systems.

10. The portable touch screen peripheral device of claim 8, further comprising:
a project retention means for linking and saving at least two specified resources that are activated upon selection of a single project/input designator.

11. The portable touch screen peripheral device of claim 8, wherein properties of said at least one project/input designator are customizable by said user, said properties are selected from the group consisting of size, shape, location, image content, video content, subject content, date content, user content, keyword content, description content, symbol content, and text content.

12. The portable touch screen peripheral device of claim 8, further comprising:
a software platform for independent application development that provides for input interactions and output interactions between said portable touch screen peripheral device and said at least one electronics system.

13. The portable touch screen peripheral device of claim 8, wherein said interactions comprise input interactions and output interactions capable of affecting a device constituent, said device constituent is selected from the group consisting of said at least one project/input designator, said on-screen items, an application-based control, another said input interaction, and another said output interaction.

14. The portable touch screen peripheral device of claim 8, wherein said interactions are initiated by an occurrence, said occurrence is selected from the group consisting of an application-based automatic offload, an event trigger, a state change, and user input.

15. A portable touch screen peripheral device providing for communication and interactions with at least one electronics systems, comprising:
a touch-responsive screen, said touch-responsive screen detecting contact from a user, wherein said touch-responsive screen is independent from said at least one electronics system; and
a project/input designator display means for displaying at least one project/input designator at specific coordinates on said touch-responsive screen, wherein properties of said at least one project/input designator are customizable by said user, said properties are selected from the group consisting of size, shape, location, image content, video content, subject content, date content, user content, keyword content, description content, symbol content, and text content;
wherein said interactions comprise input interactions and output interactions capable of affecting a device constituent, said device constituent is selected from the group consisting of said at least one project/input designator, on-screen items, an application-based control, another said input interaction, and another said output interaction;
wherein said communication between said portable touch screen peripheral device and said at least one independent electronics systems is selected from the group consisting of a wired communication means and a wireless communication means.

16. The portable touch screen peripheral device of claim 15, wherein said interactions are initiated by an occurrence, said occurrence is selected from the group consisting of an application-based automatic offload, an event trigger, a state change, and user input.

17. The portable touch screen peripheral device of claim 15, wherein said portable touch screen peripheral device communicates with at least two independent electronics systems.

18. The portable touch screen peripheral device of claim 15, further comprising:
an offloading means for offloading said on-screen items from a main display screen of said at least one electronics system to said touch-responsive screen, wherein said portable touch screen peripheral device is independent from said main display screen of said at least one electronics system.

19. The portable touch screen peripheral device of claim 15, further comprising:
a project retention means for linking and saving at least two specified resources that are activated upon selection of a single project/input designator,

20. The portable touch screen peripheral device of claim 15, further comprising:
a software platform for independent application development that provides for input interactions and output interactions between said portable touch screen peripheral device and said at least one electronics system.
